(19) United States
(12) Patent Application Publication
(10) Pub. No.: US 2002/0068584 A1
(43) Pub. Date: Jun. 6, 2002

(54) Method and system for transmitting data to a mobile device

(75) Inventors: William A. Gage, Stittsville (CA); Hongyi Li, Kanata (CA); Jerry P.L. Chow, Kanata (CA)

Correspondence Address: Alan M. Weisber, Esq., CHRISTOPHER, WEISBERG & CRUSH, P.A., 200 East Las Olas Boulevard, Suite 2040, Fort Lauderdale, FL, 33301, US

(73) Assignee: Nortel Networks Limited

(21) Appl. No.: 09/730,121

(22) Filed: Dec. 5, 2000

(51) Int. Cl. H04Q 7/20; G01S 1/00; H04B 7/185; G01S 3/02

(52) U.S. Cl. 455/456; 455/457; 455/445; 342/357.01; 342/450

(57) ABSTRACT

A system and method for transmitting data to a mobile device in which location data is received from the mobile device. A data packet is encapsulated in an encapsulation packet in which the encapsulation packet has a destination address corresponding to the location data. At least a portion of a network path to the device is determined based on the location data. The encapsulated data packet is decapsulated at a network switch. The data packet is transmitted to the mobile device.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and system for transmitting data to a mobile device, and in particular, to a method and system for high speed transmission of data to a moving mobile device by monitoring the location of the moving host and revising network data mapping tables to correspond with the new device location in a manner which minimizes device and communication signaling overhead and delay.

### BACKGROUND OF THE INVENTION

Communication with mobile devices, and in particular wireless mobile devices, has traditionally been relegated to cell-based telephone communication and data communication in which the wireless mobile device remains stationary during use. Further, data communications using modems coupled to cellular telephones provide unreliable service and very slow data communication rates. While data rates for wireless stationary devices are greater than those of cell phone modems, the stationary mobile devices do not allow relocation of the devices during use beyond a very limited range.

For example, a laptop computer equipped with a wireless local area network interface allows use within range of a local area network wireless receiver, such as may be found in a college campus classroom. However, these devices cannot be used for high speed travel and have a very small range, on the order of a few hundred feet because there is no accommodation for handing communication off from one base transceiver to another.

It is desirable to have a system which has the range and flexibility of use of a cell-based wireless system, such as a CDMA spread-spectrum communication system, and which allows high speed data communication (for example, one megabit per second and faster).

Systems have been proposed to support wireless high speed data communications using existing cell-based technology. However, because these technologies were designed to accommodate voice communication, the signaling methods employed in traditional cell-based communication systems are too slow to ensure reliable high speed data transmission. This is the case because the signaling protocols used to hand a communication session off from one base station to another takes time to process by the communication network elements and end devices. Further, the signaling communication between the network elements (routers, switches, etc.) needed to accommodate the switch from one base station to another consumes processing resources and adds delay due to the transmission of signaling information between the network elements.

For example, a traditional implementation involves the use of pre-established data tunnels between each of the end network elements in a communication network. As such, a terminal (or other device) communicating with a mobile device transmits data to the network element at one end of the tunnel. The network element encapsulates the data packet in a tunnel packet which is transmitted to the remote network element at the other end of the tunnel. The remote network element decapsulates the packet and delivers the packet to the mobile device via the communicating base station.

When the mobile device moves such that it is supported by a different network element (and base station), the network elements must communicate this change with each other such that a different pre-existing tunnel is used by the network element supporting the terminal. This arrangement disadvantageously requires the creation of tunnels between each network element at the periphery of the network and further requires that the network elements communicate the movement of the device from one end node to another so that a different, appropriate, tunnel is used.

This arrangement is inefficient due to the number of tunnels which must be created and maintained. Traditionally, the tunnels are standard encapsulation tunnels which use Transmission Control Protocol/Internet Protocol (hereinafter “TCP/IP”) addresses (also referred to herein as Internet Protocol (“IP”) addresses) to define the end points of the tunnel. Further, the signaling required by the network elements adds substantial data overhead to the network and processing overhead for the network elements. The result is that traditional cell-based communication networks have a switching delay measurable in seconds. This delay is one to two orders of magnitude greater than needed to adequately support high speed data communication such as that needed for real time streaming data, for example, voice over Internet Protocol (hereinafter “VoIP”) and video streaming.

Also, because many wireless network providers have made a substantial investment in the communication infrastructure, i.e. routers, switches, communication links, and the like, these providers are reluctant to build parallel networks using new equipment to support high speed data communication. However, these devices are typically software-upgradeable in order to comply with contemporary data communication protocols and standards. It is, therefore, further desirable to have a system which uses existing hardware elements to support high speed data communication.

Proposals have recently been made to require wireless communication devices, such as cell phones, to incorporate global positioning system (hereinafter “GPS”) receivers and hardware so that the devices can determine and report their location to other system elements. This is particularly necessary for locating the mobile device in the event of an emergency, for example, a “911” call.

It is desirable to have a communication system which uses GPS location data provided by the device to identify those network elements supporting the device at its present location so that data transmitted to the device can be efficiently routed to the appropriate network element. It is further desirable to use the GPS location data to facilitate data packet routing to the new corresponding network elements without incorporating excessive signaling and delay, thereby facilitating an uninterrupted high speed data stream such as those supporting the VoIP and streaming video applications.

### SUMMARY OF THE INVENTION

The present invention provides a method and system which uses location data, such as GPS location data or routing domain data, provided by the device to identify those network elements supporting the device at its present location so that data transmitted to the device can be efficiently routed to the appropriate network elements, thereby minimizing signaling and delay. This arrangement facilitates an uninterrupted high speed data stream to support, among other things, VoIP and streaming video applications.

Further, an arrangement of the present invention employs the use of routing domains to identify the location of the mobile device. The use of routing domains allows packet routing to advantageously be accomplished using known multicast packet routing techniques within the communication network.

One aspect of the present invention provides a method for transmitting data to a mobile device, in which location data is received from the mobile device. A data packet is encapsulated in an encapsulation packet. The encapsulation packet has a destination address corresponding to the location data. At least a portion of a network path to the device is determined based on the location data. The encapsulated data packet is decapsulated at a network switch. The data packet is transmitted to the mobile device.

As another aspect, the present invention provides a system for transmitting data across a communication network from a terminal to a mobile device, in which at least one first router has at least one communication interface. The at least one communication interface receives location data from the mobile device. At least one second router has at least one communication interface and a central processing unit. The communication interface receives the location data from the first router and receives a data packet from the terminal. The data packet includes a unicast address of the mobile device. The central processing unit executes functions including determining at least a portion of a network path to the device based on the location data and using the portion of the determined network path to send, via the communication interface, the data packet to the first router which received the location data from the device.

According to still another aspect, the present invention provides a network switch for a communication network in which the network switch facilitates communication between a device and a terminal coupled to the communication network. The network switch has at least one communication interface and a central processing unit. The communication interface receives location data corresponding to the device and receives a data packet from the terminal. The data packet includes a destination unicast address of the device. The central processing unit executing functions including determining at least a portion of a network path to the device based on the location data and using the portion of the determined network path to send, via the at least one communication interface, the data packet to the device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a communication system constructed in accordance with the principles of the present invention;

FIG. 2 is a block diagram of a hardware arrangement of a network edge router constructed in accordance with the principles of the present invention;

FIG. 3 is a diagram of an exemplar arrangement of the hardware elements of a first arrangement of the present invention;

FIG. 4 is an example of a global position route table;

FIG. 5 is a flow chart of the location update process of the first arrangement;

FIG. 6 is an example of a packet arrangement by which GPS location data is provided to network edge routers;

FIG. 7 is an example of a position table stored by the network edge routers;

FIG. 8 is a flow chart of the overall operation of the data packet routing aspect of the present invention based on global position location data;

FIG. 9 is an example of an encapsulation packet constructed in accordance with the first arrangement of the present invention;

FIG. 10 is an example arrangement of the hardware elements of the second arrangement of the present invention;

FIG. 11 is flow chart of the location update process implemented in the second arrangement of the present invention;

FIG. 12 is a diagram of a packet arrangement by which routing domain location data is provided to network edge routers;

FIG. 13 is an example of a position table stored by network edge routers in accordance with the second aspect of the present invention;

FIG. 14 is a flow chart of the data packet routing aspect of the present invention based on routing domain location data;

FIG. 15 is a multicast table; and

FIG. 16 is an example of an encapsulation packet arrangement constructed in accordance with the principles of the second aspect of the present invention.

### DETAILED DESCRIPTION OF THE INVENTION

Initially, it is noted that the term “data” as used herein refers generally to the content being transported from one location, device, element, etc., to another, regardless of form. For example, “data” as used herein can include voice content as well as non-voice content and device location information, and can include overhead data such as packetizing information, headers, error checking codes, etc. Specific types of data or packet components such as headers are noted as such herein, where appropriate.

The term “mobile device” as used herein includes wireless devices and wired devices which are readily capable of moving from location to location such as a laptop personal computer, personal digital assistant (PDA) and the like.

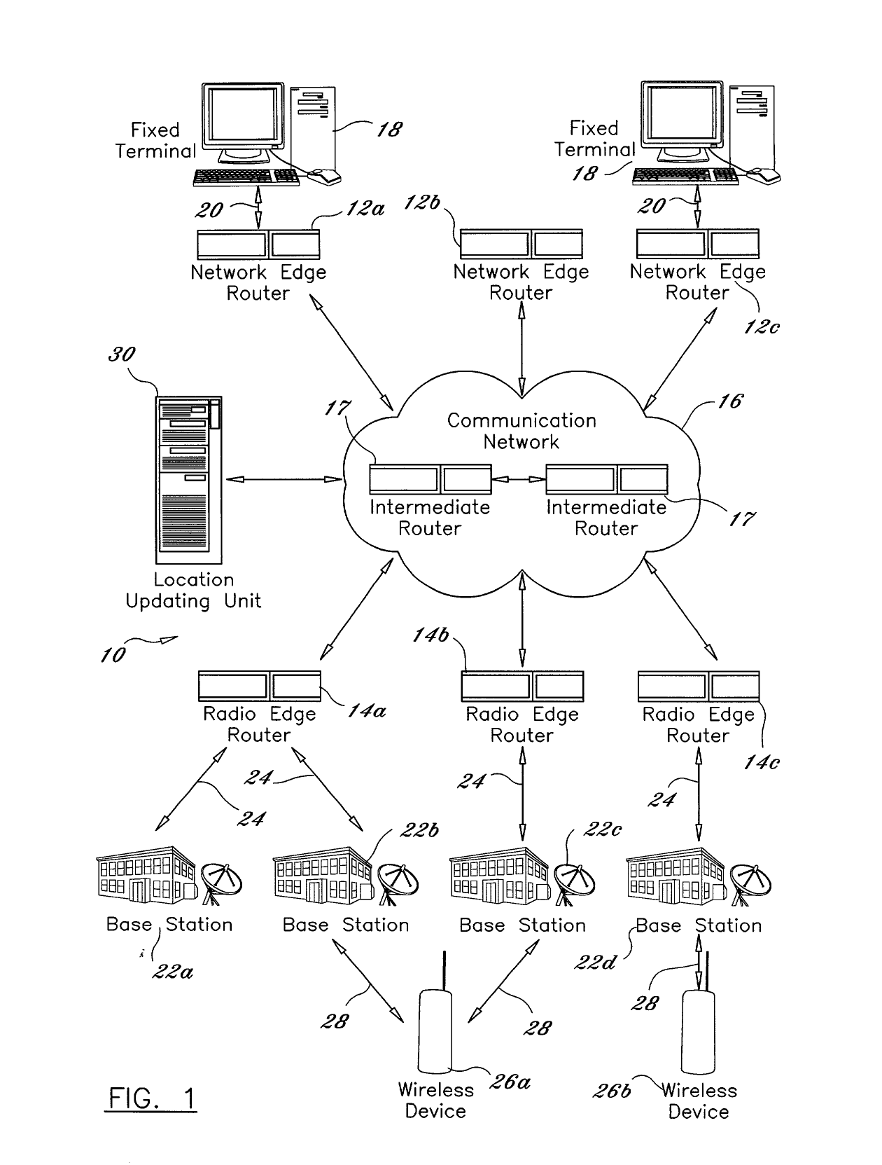

Referring now to the drawing figures in which like reference designators refer to like elements, there is shown in FIG. 1 a communication system constructed in accordance with the principles of the present invention and designated generally as 10. Communication system 10 preferably includes one or more network edge routers 12 (shown in FIG. 1 as network edge routers 12a, 12b and 12c) coupled to one or more radio edge routers 14 (shown in FIG. 1 as radio edge routers 14a, 14b and 14c) via communication network 16. Each network edge router transmits data to, and receives data from, terminal 18 via terminal communication link 20.

Communication system 10 also includes one or more base stations 22 (shown in FIG. 1 as base stations 22a, 22b, 22c and 22d) coupled to one or more radio edge routers 14 via base station communication link 24.

Communication system 10 further includes one or more mobile devices 26 (shown in FIG. 1 as mobile devices 26a and 26b) wirelessly communicating with one or more base stations 22 via wireless communication link 28.

Optionally, communication system 10 includes one or more location updating units 30 for forwarding location data such as GPS location data or routing domain data, both of which are discussed below in detail, to network edge routers 12.

Although the drawing figures and the accompanying description refer to “routers” for network edge routers 12 and radio edge routers 14, the present invention is not limited to such as this term is commonly known in and used in the art. It is contemplated that any device which receives a data packet and determines an appropriate interface for sending the packet or relevant portions of the packet out a communication interface to another device can be used. As such, although the term “router” is used and discussed herein, it is understood that any suitable network switching element is applicable to the present invention.

Communication network 16 is preferably any communication network capable of transporting data between network edge routers 12 and radio edge routers 14. As such, communication network 16 can include intermediate network routers 17 which receive a data packet, evaluate the data packet header information and transmit the packet to the next hop in the transmission path from origination to destination. Devices for generally switching data packets between a receiving communication interface and a transmitting communication interface are known. However, intermediate network switching elements which are arranged to support the advantageous routing function embodied by the present invention are described in detail below.

Terminal 18 is any computing device arranged to transmit and receive data to and from mobile devices 26. Non-limiting examples of terminals 18 include personal computers, enterprise servers, web application servers, data repositories and the like. Further, although terminals 18 are generally stationary hard-wired devices, it is contemplated that any terminal which can communicate with a network edge router 12 can be used, even if the terminal 18 is wireless, for example, stationary mobile devices. It is also contemplated that terminal 18 can be a mobile terminal similar to mobile device 26. In this case, communication from mobile device 26 to terminal 18 occurs as described below with respect to communication from terminal 18 to mobile device 26.

Mobile device 26 preferably is any device arranged for wireless communication, including a cellular telephone, a wireless personal digital assistant (PDA), a laptop or other personal computer configured with a wireless transceiver. Preferably, mobile device 26 communicates with base stations 22 using code division multiple access spread-spectrum mobile device communication links 28. However, any wireless communication medium is suitable for use as wireless communication links 28 as long as those communication links support high speed user data and the transmission of location data as discussed below in detail.

Base stations 22 are preferably any base station arrangement capable of communicating with mobile device 26 across communication network 28. For example, base station 22a can communicate with mobile device 26a using a code division multiple access spread-spectrum signal via wireless communication link 28 in order to transmit data to mobile device 26a and receive data from mobile device 26a, including location data. Base station arrangements of this type are known. It is further contemplated that both base stations 22 and mobile devices 26 communicate using TCP/IP or any other suitable data communication protocol.

It is contemplated that mobile devices 26 can be wired devices such that communication between mobile devices 26 and their corresponding base stations 22 is implemented using wired connections, such as might be encountered when relocating a laptop computer from LAN segment to LAN segment within a campus environment.

Base station communication link 24 communicates with radio edge router 14 using a protocol such as TCP/IP and the like. Base station communication link 24 can be a wired or wireless communication link such as a serial line interface protocol/point-to-point protocol (SLIP/PPP) link, integrated services digital network (ISDN) link, dedicated leased-line service, broadband (cable) access, frame relay, digital subscriber line (DSL), asynchronous transfer mode (ATM), fiberoptic, or wireless-based communication connection. Terminal communication link 20 takes the form of those communication links described with respect to base station communication links 24. Terminal communication link 20 and base station communication link 24 can also take the form of a shared network facility, such as a local area network.

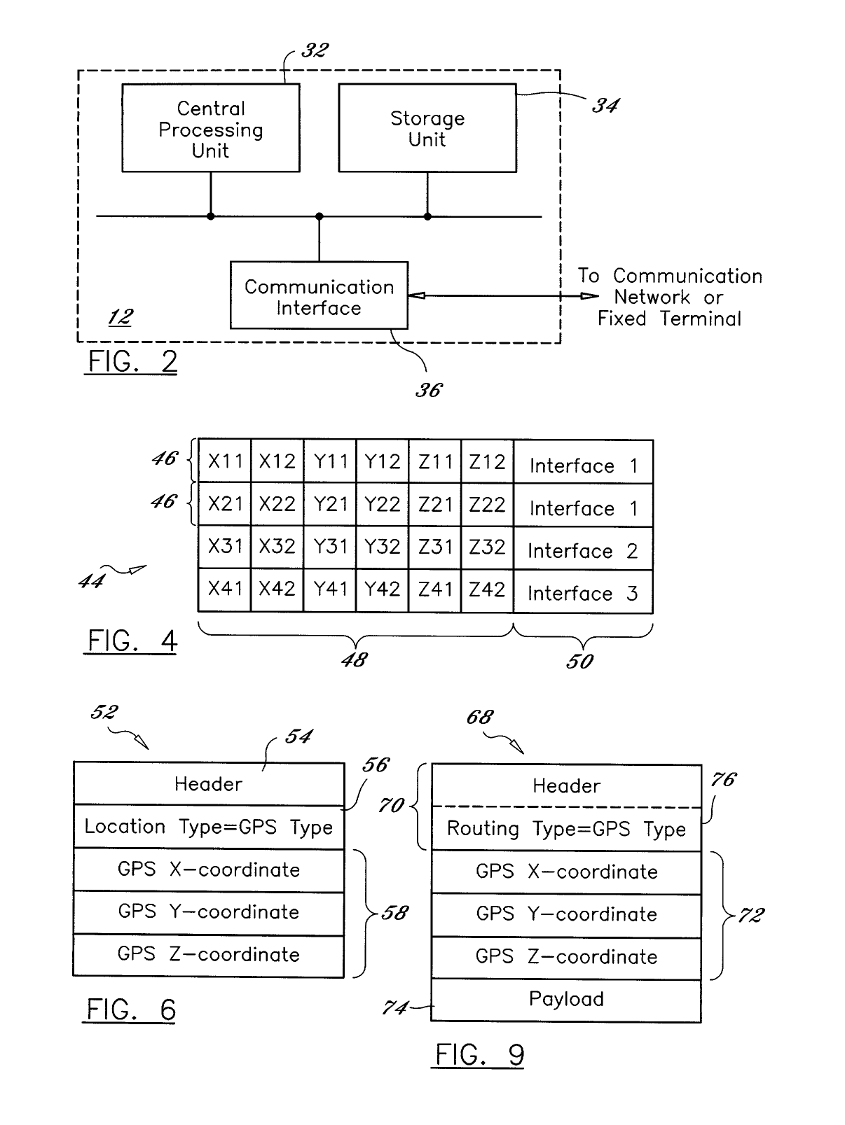

Radio edge routers 14 and network edge routers 12 are any network switching element which can support the below-described functions. FIG. 2 is a block diagram of a hardware arrangement of network edge routers 12 constructed in accordance with the principles of the present invention. It is understood that the same hardware elements can be used for radio edge routers 14 and intermediate routers 17 within communication network 16. Network edge routers 12 include central processing unit 32, storage unit 34 and communication interface 36. Multiple central processing units, storage units and communication interfaces can be included in network edge router 12, as necessary, based on the capacity requirements to be supported.

Central processing unit 32 is an arrangement of circuit elements which access storage unit 34 and communication interface 36 in order to carry out the below-described functions of network edge router 12. Storage unit 34 is arranged to store programmatic data required for the operation of network edge router 12, store operational data such as data packets received from communication interface 36 or to be transmitted to communication interface 36, i.e. buffering, and the like. Storage unit 34 preferably includes one or more of: random access memory (RAM), read only memory (ROM), fixed non-volatile storage such as hard disks and removable non-volatile storage such as floppy disk drives, CD drives, DVD drives and the like.

Communication interface 36 is comprised of those hardware and programmatic code elements required to transmit data to other system elements and to receive data from other system elements. It is also contemplated that communication interface 36 can include buffering hardware, as needed.

Location updating unit 30, coupled to communication network 16, is any processing unit capable of receiving data packets having location data from radio edge routers 14 and forwarding the location data to network edge routers 12. For example, location updating unit 30 can be a server performing other functions in addition to the location forwarding function or can be a network switching element similar to, or the same as, routers 12, 14 and 17.

Location updating unit 30, network edge routers 12 and radio edge routers 14 are coupled to communication network 16 by any arrangement suitable for transmitting and receiving data to and from the elements of communication network 16. Routers 12 and 14 are preferably coupled to communication network 16 via one or more respective communication interfaces 36. The communication links are preferably high speed multi-megabit per second communication links arranged to transport suitable communication protocols such as the TCP/IP suite of protocols. The communication links preferably take the form of fiberoptic links, broadband links, leased serial lines and the like.

The present invention advantageously provides two separate arrangements by which high speed data communication between mobile device 26 and terminal 18 is facilitated. The first arrangement establishes communication and data packet routing based on the global position of mobile device 26 determined, for example, from a GPS receiver (not shown) included as part of mobile device 26. The device reports its location to radio edge router 14 or, optionally, location updating unit 30. This position location data is sent to network edge routers 12 which use the location data to establish routing paths for data packets destined for mobile device 26 to the radio edge router(s) 14 supporting mobile device 26.

The second arrangement facilitates routing of data packets to the radio edge router(s) 14 supporting mobile device 26 by establishing routing domains. In a routing domain environment, a data packet is transmitted to a multi-cast address in which the multi-cast address corresponds to all of the radio edge routers 14 in a given routing domain. Each of the different routing arrangements are described below in detail.

Initially, it is noted that the operational descriptions of the present invention with respect to both of the first and second aspects of the present invention is made regarding data communication from fixed terminal 8 to mobile device 26. This is the case because routing of data packets from mobile device 26 to a stationary terminal 18 is accomplished using known techniques such as routing of IP packets to a non-moving device which has a corresponding unicast address. Conversely, because mobile device 26 moves from radio edge router to radio edge router, and although mobile device 26 has a unicast address associated with it, such as an IP address, the path from terminal 18 to mobile device 26 changes as mobile device 26 moves to a different radio edge router 14. As such, the network edge router 12 receiving a data packet from terminal 18 must be able to quickly adapt to the movement of mobile device 26 from one coverage zone (or routing domain) to another so that data packets destined for mobile device 26 are routed in the most efficient and optimal manner, i.e. with minimal delay, through communication network 16 to supporting radio edge routers 14.

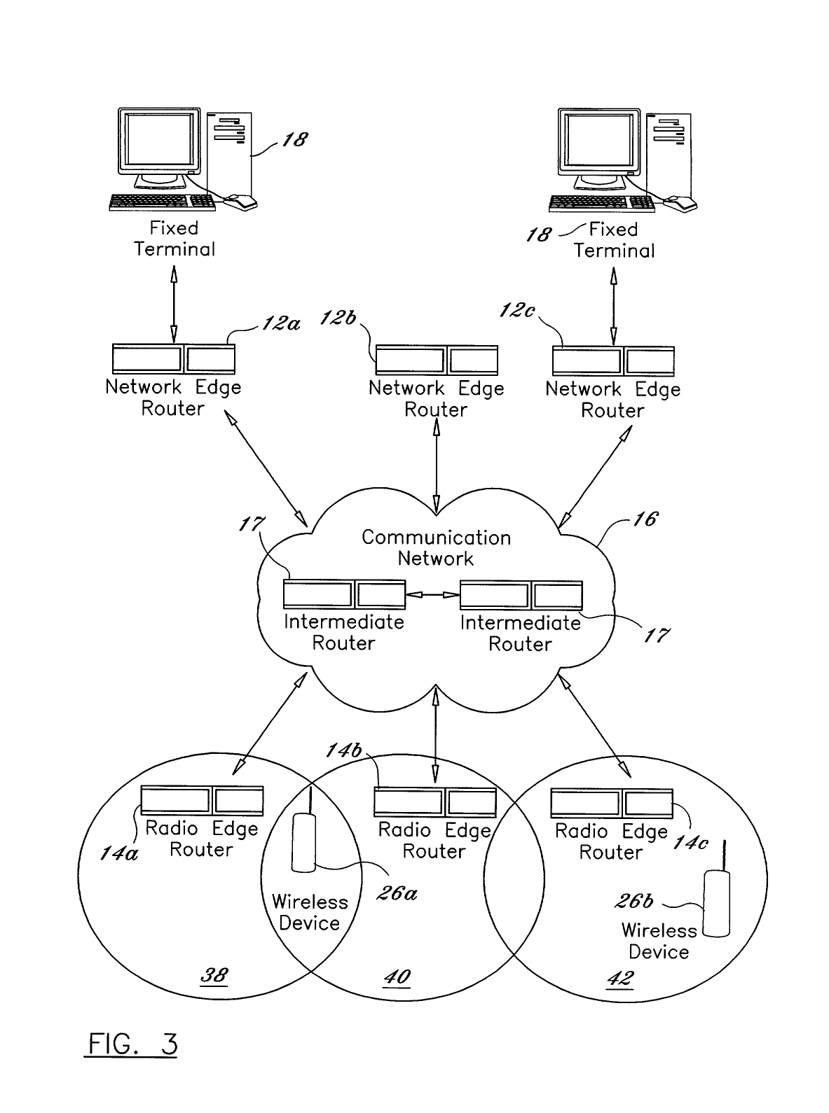

FIG. 3 shows an example arrangement of the hardware elements supporting the first arrangement of the present invention in which data packet delivery is based on the global position of mobile device 26. It should be noted that base stations 22 are not shown in FIG. 3 for the sake of simplicity, it being understood that mobile devices 26 communicate with radio edge routers 14 via one or more base stations 22.

As shown in FIG. 3, each radio edge router 14 supports a particular coverage zone in which mobile devices transmitting and receiving data communicate. For example, radio edge router 14a supports coverage zone 38, radio edge router 14b supports coverage zone 40 and radio edge router 14c supports coverage zone 42. Coverage zones 38, 40 and 42 are defined by a set of global position coordinate ranges. Further, although coverage zones 38, 40 and 42 are shown as ovals, those of skill in the art will appreciate that the coverage zones are based on the base station coverage zones which are supported by a corresponding radio edge router 14 and can take the form of any shape.

Further, it is contemplated that coverage zones can overlap. For example, mobile device 26a is shown in FIG. 3 as being in coverage zone 38 and coverage zone 40. Mobile device 26b is shown as being in coverage zone 42. As such, mobile device 26b sends and receives data to and from other devices and terminals 18 via radio edge router 14c, while mobile device 26a sends and receives data to and from network elements and terminal 18 via one or both of radio edge routers 14a and 14b.

Because routing from network edge router 12 through communication network 16 to the destination radio edge router 14 in this arrangement is based on the global position of mobile device 26, network edge router 12 and the intermediate routers 17 in communication network 16 must have data which allows the network switching element (network edge router 12 and intermediate routers 17 in communication network 16 in this case) to determine which communication interfaces 36 to use to transmit the data packet on its path to designated radio edge routers 12.

The mapping of the coverage zones to the communication interfaces 36 from which the radio edge routers 14 supporting the coverage zones can be reached is stored in storage unit 34 and evaluated by central processing unit 32. An example of this stored mapping is shown in FIG. 4 as global position route table 44. Global position route table 44 includes one or more route entries 46, each of which include a coverage area range 48 and corresponding interface entry 50. Interface entry 50 refers to the communication interface 36 to use to reach a corresponding coverage area range 48. Each coverage area range 48 entry includes the X, Y and Z ranges associated with the coverage zone for a particular radio edge router 14. For example, the radio edge router 14 which supports the coverage zone enclosed by X11 to X12, Y11 to Y12 and Z11 to Z12 is reached by transmitting the data packet via the communication interface 36 known as interface 1. Of course, coverage area range 48 is not limited to a two dimensional model for each of the X, Y and Z coordinates and can be more detailed, as necessary, based on the complexity of the shape of the corresponding coverage area.

Global position route table 44 is stored in each of network edge routers 12 and intermediate routers 17. Because the routing information is based on coverage zones and not the location of device 26 which can move, global position route tables 44 remain static. As such, network edge routers 12 and intermediate routers 17 need not expend a significant amount of processing resources conducting routing table updates. Global position route table 44 can therefore be entered manually in each network edge router 12 and intermediate router 17 within communication network 16 (and optionally radio edge router 14), or can be dynamically transmitted by radio edge router 14 each time a coverage zone changes. Coverage zone changes may occur, for example, when a new radio edge router 14 is added to system 10, when a radio edge router 14 fails or when another configuration change is made to system 10 which affects coverage zones, such as addition or removal of a base station 22.

In order to route a data packet using location data for mobile device 26 which corresponds to the global position of mobile device 26, each mobile device 26 must provide its location data to network edge routers 12. This can be done by transmitting the location data to radio edge routers 14 in the coverage zone of the mobile device 26, which then disseminates the location data to network edge routers 12. In the alternative, mobile device 26 can send its location data to location updating unit 30 which distributes the location data to network edge routers 12. Further, in the case of multiple location updating units 30, wireless device 26 can use an anycast address to deliver the location data to the location updating unit 30 closest to the radio edge router 14 which receives the location data packet.

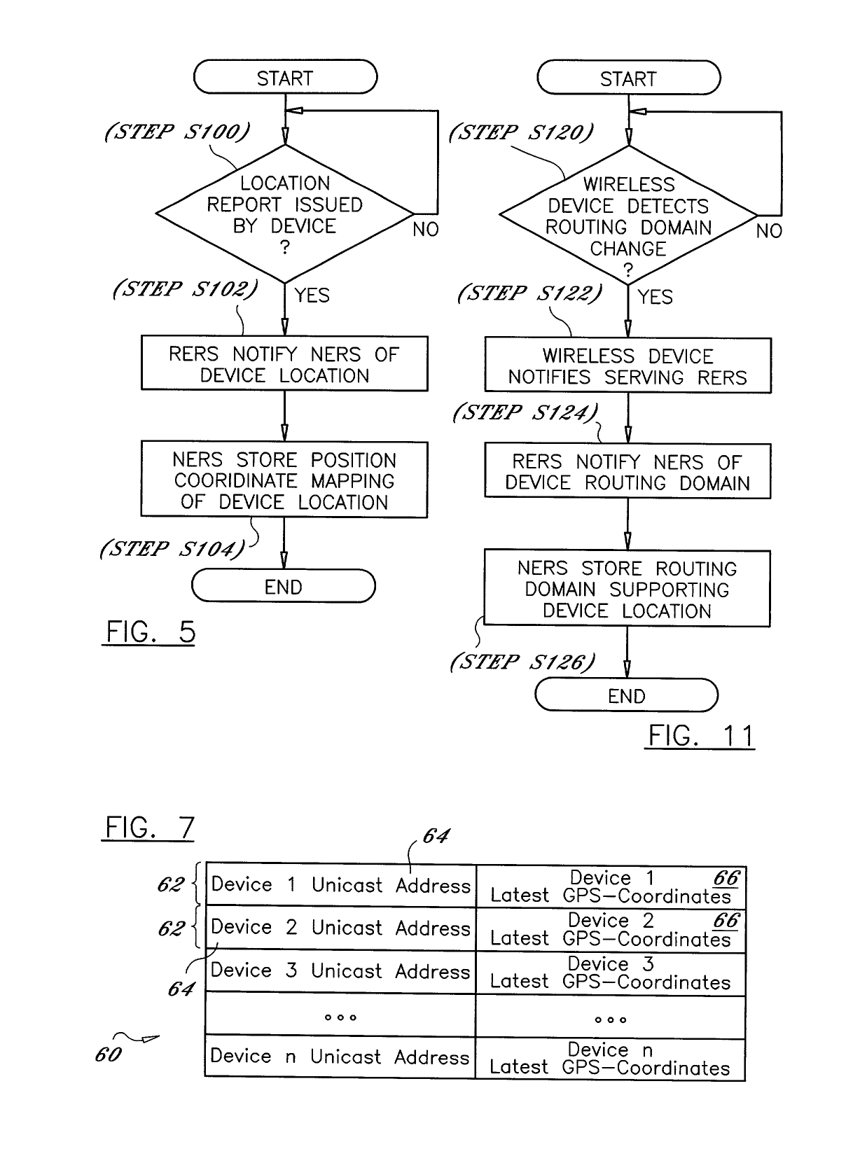

FIG. 5 is a flow chart of the location update process implemented in the present arrangement. Although FIG. 5 is explained with reference to radio edge router 14 receiving the location data for subsequent distribution to network edge routers 12, it is understood that location updating units 30 can be used instead of, or in addition to, radio edge routers 14. Mobile device 26 monitors itself to determine when to issue a location report (step S100). Location reports can be issued periodically, e.g. every N seconds or based on a change in location which exceeds a predetermined distance. The location report issued by mobile device 26 preferably includes the unicast address of the mobile device or other identifier, along with the GPS location, i.e., X, Y and Z coordinates of the device.

Upon receipt of the location report, the receiving radio edge routers 14 (RERs) notify the network edge routers (NERs) 12 of the device location (step S102) by sending a location data packet to network edge routers 12. An example packet arrangement by which GPS location data is provided to network edge routers 12 is shown in FIG. 6. GPS location data packet 52 is preferably comprised of location data packet header 54, location type identifier 56 and GPS coordinates 58. Header 54 is any header which is routeable by radio edge router 14, network edge routers 12 and the elements in communication network 16, for example, an Internet Protocol version 6 (IPv6 packet). IPv6 packet arrangements are known. Location data packet header 54 includes the unicast address of mobile device 26 as the source address of the packet.

Location type identifier 56 is shown in FIG. 6 as set to GPS type. This alerts network edge routers 12 that the data content in GPS location data packet 52 is GPS location data.

GPS location data packet 52 is formed by mobile device 26 or, in the alternative, by the radio edge router 14 which supports mobile device 26. In the latter case, formation is based on extracting the GPS location data from the data stream transmitted from mobile device 26 to radio edge router 14.

Referring again to FIG. 5, upon receipt of GPS location data packet 52 sent by the receiving radio edge router 14 to network edge routers 12 (step S102), network edge routers 12 store the updated GPS coordinate information as a mapping between the unicast address of mobile device 26 to its latest GPS coordinates (step S104).

An example of a position table stored by network edge routers 12 based on location data received via GPS location data packet 52 is shown in FIG. 7. Device position table 60 preferably includes of one or more device map rows 62, preferably one device map row 62 for each of devices of 1 to n active in system 10. Each device map row 62 includes device address entry 64 along with its corresponding GPS coordinates 66 as received in GPS location data packet 52. Device address entry 64 is the unicast address of mobile device 26.

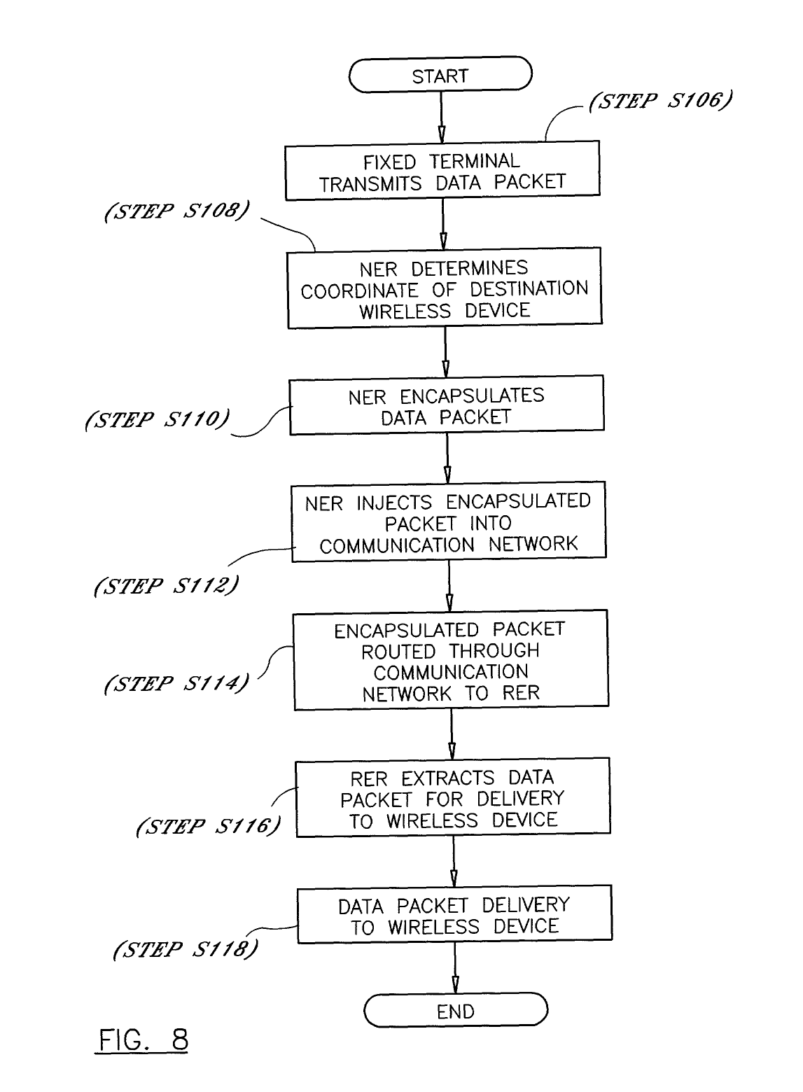

The overall operation of the data packet routing aspect of the present invention based on global position location data is described with reference to FIG. 8. Initially, terminal 18 transmits a data packet destined for mobile device 26, for example mobile device 26a (step S106). Terminal 18 uses the unicast address such as the IP address of device 26 as the destination address. Network edge router (NER) 12 determines the global position coordinates of the destination mobile device by searching its storage device position table 60 (step S108). By knowing the latest GPS coordinates, network edge router 12 can determine which communication interfaces 36 to use. This is done by evaluating stored global position route table 44 to determine the interface entries 50 which corresponds to the coverage area range 48 in which the GPS coordinates of destination mobile device 26 is currently resident. Using this information, network edge router 12 encapsulates the data packet sent from fixed terminal 8 in a packet having a destination address based on the global position data, for example, the GPS X, Y and Z coordinates (step S110).

FIG. 9 shows an example of an encapsulation packet arrangement constructed in accordance with the principles of the first aspect of the present invention. Global position encapsulated packet 68 constructed by network edge router 12 corresponding to the sending terminal 18 preferably includes encapsulation header 70, GPS routing header 72, and user data payload 74. Encapsulation header 70 includes information such as the original source unicast address and destination address, along with other header data found in typical packet headers such as an IPv6 header. It is contemplated that a type 43 routing header, a standard extension header type available under IPv6, can be used to form an encapsulation packet header. Encapsulation header 70 includes a routing type identifier which is set to designate that packet routing is based on GPS location data.

GPS routing header 72 includes the global position X, Y and Z coordinates as established by evaluating device position table 60. User data payload 74 is the user data content sent by terminal 18.

Referring again to FIG. 8, network edge router 12 injects the encapsulated packet into communication network 16 (step S112) by transmitting the encapsulated packet via communication interfaces 36 corresponding to the coverage area range in which the destination device resides. Recall that the determination is made by evaluating global position route table 44.

The encapsulated packet is routed through the communication network to the destination radio edge router (RER) (step S114). Intermediate routers 17 within communication network 16 evaluate GPS routing header 72 of the received global position encapsulated packet 68 to determine which communication interfaces 36 to use to transmit the encapsulated packet. Routing in this manner continues until the encapsulated packet arrives at radio edge routers 14 supporting destination mobile device 26. Upon receipt, each supporting radio edge router 14 removes routing header 72 and retrieves the original data packet (header 70 and data payload 74) for delivery to the mobile device (step S116). The data packet is delivered to the destination mobile device (step S118) via the wireless communication portion of the network, for example, base stations 22 and base station communication links 24.

It is noted that this aspect of the present invention advantageously provides macro diversity. It is further contemplated that alternate forms of macro diversity support can be used. For example, a proxy device similar to location updating unit 30 can be used to transmit multiple copies of the encapsulated packet to the corresponding radio edge routers, thereby relieving network edge router 12 of the burden of generating and transmitting multiple packets. Further, macro diversity can be implemented in one or more of the radio edge routers 14 which, upon recognizing that the receiving encapsulated packet is supported by additional radio edge routers 14, can transmit copies of the encapsulated packet to the other radio edge routers 14 for delivery to the mobile device 26. In other words, network edge routers and 12 and intermediate routers 17 can be configured to function as radio edge routers, i.e. support base stations 22.

This aspect of the present invention advantageously provides an environment in which network initialization conveniently does not require any pre-configuration of network topology. Further, no routing protocols need to be exchanged between routers because routing is based on generally fixed coverage zones. Although mobile device 26 moves from coverage zone to coverage zone, routing of the packet via an appropriate communication interface 36 is based on a table lookup, and not a complicated signaling protocol. The result is that the present invention advantageously minimizes processing resources and avoids the delays added by conventional signaling requirements. As such, this aspect of the present invention allows high speed data communication between terminal 18 and mobile device 26 in a manner which does not facilitate dropped data packets due to network delay and buffering overflow. The present invention provides a system by which voice over IP, video streaming and other high data rate applications requiring high packet delivery percentages are supported.

The second aspect of the present invention provides an environment in which known hardware components can be used as intermediate routers 17 by supporting the use of known packet headers and routing methods based on routing domains. The stored data structures, i.e., mapping tables and data packet distribution methods, employed in this aspect minimize signaling and routing delays.

As such, this aspect of the present invention advantageously allows service providers the ability to re-use their existing infrastructure. Further, this aspect of the present invention advantageously allows known packet header arrangements to be used to transport the data from terminal 18 to destination mobile device 26 in a manner which facilitates high speed, reliable data transfer suitable for video streaming and other high rate packet delivery applications.

FIG. 10 shows an example arrangement of the hardware elements supporting the second arrangement of the present invention which data packet delivery is based on the routing domain of radio edge routers 14 in which mobile device 26 is located. It should be noted that base stations 22 are not shown for the sake of simplicity, it being understood that mobile devices 26 communicate with radio edge routers 14 via one or more base stations 22.

As shown in FIG. 10, each radio edge router is part of one or more routing domains in which mobile devices transmitting and receiving data are resident. For example, radio edge routers 14a and 14b are part of routing domain 78 and radio edge routers 14b and 14c are part of routing domain 80. Routing domains 78 and 80 support a set of base stations which define coverage area. For example, mobile device 26a is shown in FIG. 10 as being in routing domain 78. Mobile device 26b is shown as being in routing domain 80. As such, mobile device 26b sends and receives data to and from other devices and terminals 18 via radio edge router 14c, while mobile device 26a sends and receives data to and from network elements and terminal 18 via radio edge router 14a.

As with the above-described first aspect, because routing from network edge router 12 through communication network 16 to the destination radio edge router 14 in this arrangement is based on the location of mobile device 26, network edge router 12 and the intermediate routers 17 in communication network 16 must have data which allows the network switching element (network edge router 12 and intermediate routers 17 in communication network 16 in this case) to determine which communication interface 36 to use to transmit the data packet. In the present aspect, the location is based on the routing domain. As such, references to location and location data in describing the present aspect refer to the routing domain in which device 26 resides.

Routing domains refer to the grouping of network elements into a single administrative destination in which data packets sent to a routing domain are sent to all or a subset of the network elements in the routing domain. This is accomplished, for example, by assigning a multicast address to the routing domain in which data packets are transmitted to the multicast address. Techniques for routing multicast packets are known, for example, in the TCP/IP protocol suite.

A multicast route table, described in detail below, associating a multicast address for a routing domain with its corresponding communication interface(s) 36 is stored in each of network edge routers 12. Because the routing information is based on routing domains and not the location of device 26 which can move, multicast route tables remain static presuming there are no failures within the network requiring routing changes. As such, network edge routers 12 and intermediate routers 17 need not expend a significant amount of processing resources conducting routing table updates. The multicast route table can therefore be entered manually in each network edge router 12, and intermediate router 17 within communication network 16 (and optionally radio edge router 14), or can be dynamically transmitted by radio edge router 14 each time a routing domain changes. In general, techniques for routing data packets to multicast addresses are known. Routing domain changes may occur, for example, when a new radio edge router 14 is added to system 10, when a radio edge router 14 fails or when another configuration change is made to system 10 which affects routing domain distribution, such as addition or removal of a base station 22.

In order to route a data packet using location data for mobile device 26 which corresponds to the routing domain in which mobile device 26 is resident, each mobile device 26 must provide its location data to network edge routers 12. This can be done by transmitting the location data to radio edge routers 14 in the form of a routing domain, which then disseminate the location data to network edge routers 12. Device 26 learns of its routing domain(s) by receiving routing domain assignments from corresponding radio edge routers 14. Radio edge routers 14 are preconfigured with one or more routing domain assignments based on engineered coverage of the base stations. In the alternative, mobile device 26 can send its routing domain location data to location updating unit 30 which distributes the location data to network edge routers 12. Further, in the case of multiple location updating units 30, wireless can device 26 can use an anycast address to deliver the location data to the location updating unit 30 closest to the radio edge router 14 which receives the location data packet.

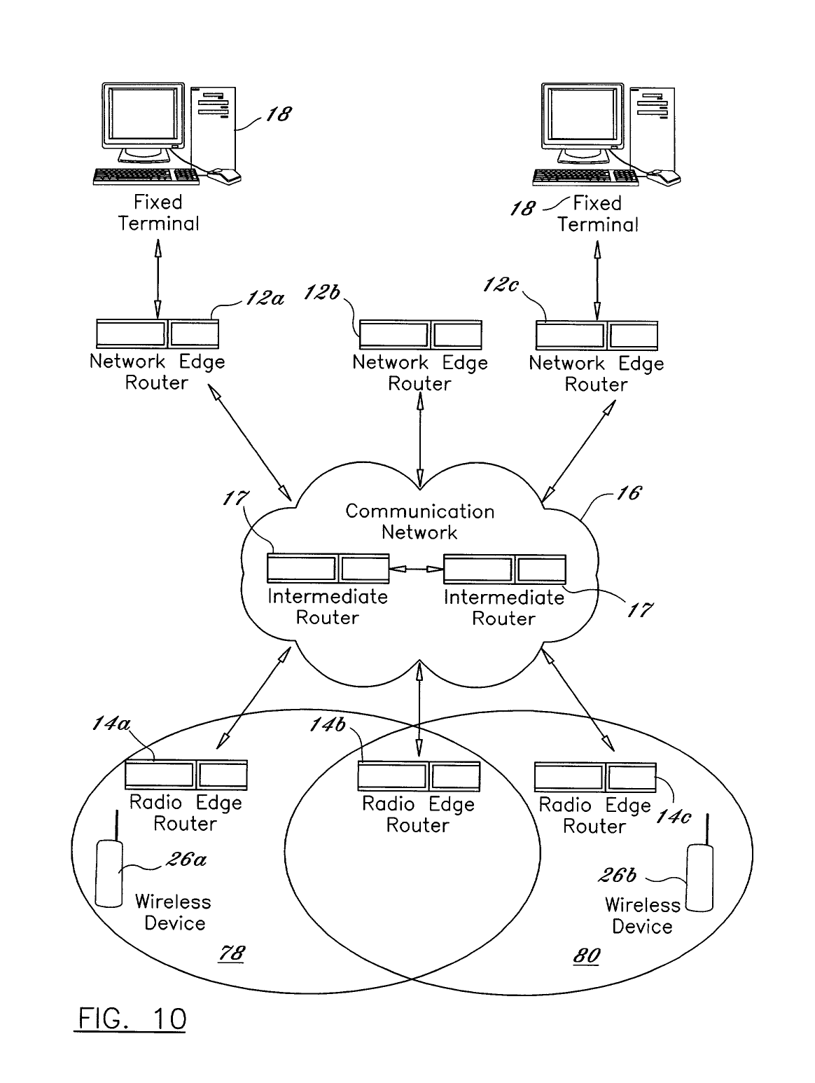

FIG. 11 is a flow chart of the location update process implemented in the present arrangement. Although FIG. 11 is explained with reference to radio edge routers 14 receiving the location data for subsequent distribution to network edge routers 12, it is understood that location updating units 30 can be used instead of, or in addition to, radio edge routers 14. Mobile device 26 monitors itself to detect a change in its routing domain assignments (step S120). If a routing domain assignment change is detected, such as occurs when device 26 moves to a different routing domain, device 26 notifies the radio edge routers in its routing domain of the change (step S122).

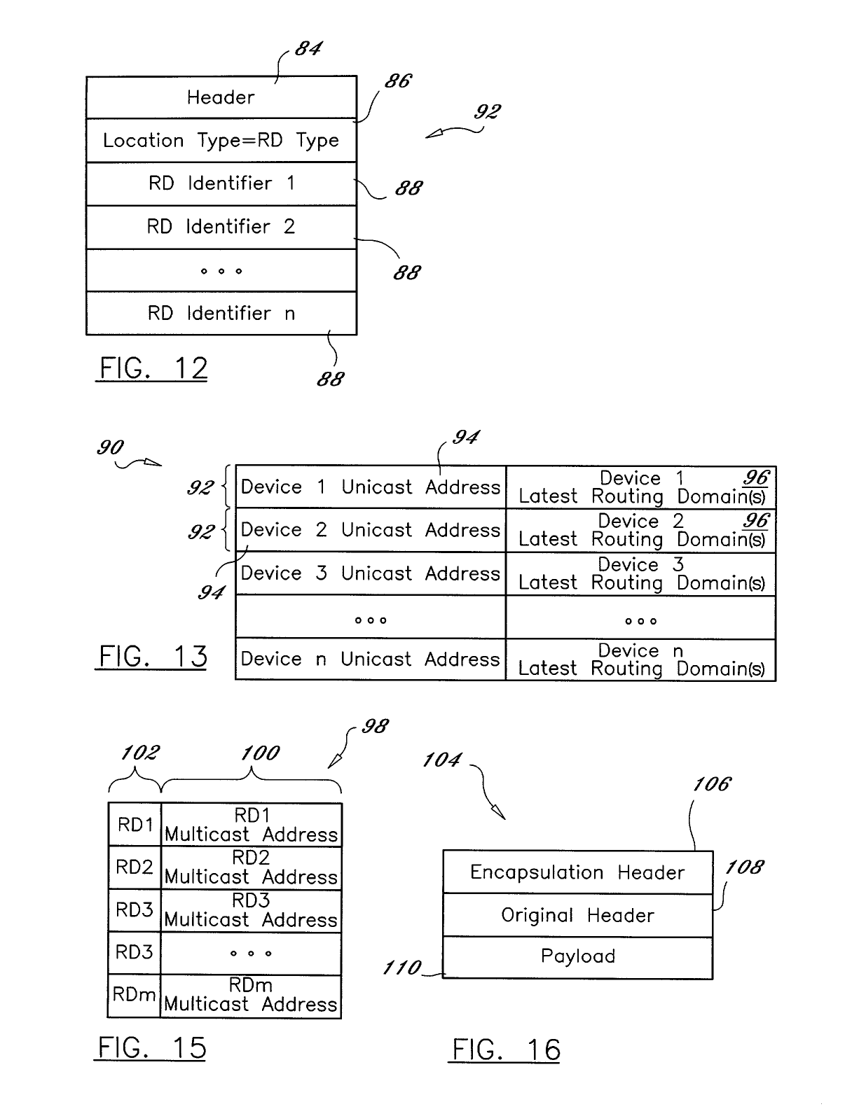

Upon receipt of the notification, the receiving radio edge routers 14 notify the network edge routers 12 of the device routing domain by sending a location data packet to network edge routers 12 (step S124). An example packet arrangement by which routing domain location data is provided to network edge routers 12 is shown in FIG. 12. Routing domain location data packet 82 preferably includes location data packet header 84, location type identifier 86 and routing domain identifiers 88. Header 84 is any header which is routeable by radio edge routers 14, network edge routers 12 and the elements in communication network 16, for example, an IPv6 packet. Location data packet header 84 includes the unicast address of mobile device 26 as the source address of the packet.

Location type identifier 56 is shown in FIG. 6 as set to RD type. This alerts network edge routers 12 that the data content in routing domain location data packet 82 is routing domain location data.

Routing domain location data packet 82 is formed by mobile device 26 or, in the alternative, by radio edge router 14 which supports mobile device 26 by extracting the routing domain location data from the data stream transmitted from mobile device 26 to radio edge router 14.

Referring again to FIG. 11, upon receipt of routing domain location data packet 82 sent by the receiving radio edge router 14 to network edge routers 12 (step S124), network edge routers 12 store the updated routing domain information as a mapping between the unicast address of mobile device 26 to its latest routing domains (step S126).

An example of a position table stored by network edge routers 12 based on location data received via routing domain location data packet 82 is shown in FIG. 13. Device routing domain table 90 is arranged to include one or more device map rows 92, preferably one device map row 92 for each of devices of 1 to n active in system 10. Each device map row 92 includes device address entry 94 along with its corresponding routing domains 96 as received from routing domain location data packet 82. Device address entry 94 is the unicast address of mobile device 26.

The overall operation of the data packet routing aspect of the present invention based on routing domain location data is described with reference to the flow chart shown in FIG. 14. Initially, terminal 18 transmits a data packet destined for mobile device 26, for example mobile device 26a (step S128). Terminal 18 uses the unicast address, such as the IP address, of device 26. Network edge router (NER) 12 determines the routing domain of the destination mobile device by searching its storage device routing domain table 90 (step S130). Knowing the current routing domain of the device, network edge router 12 determines which multicast address and therefore which communication interfaces 36 to use by evaluating stored multicast table 98, an example of which is shown in FIG. 15, to determine the multicast address 100 which corresponds to the routing domain 102 in which the mobile device 26 resides. Using this information, network edge router 12 encapsulates the data packet sent from fixed terminal 8 in one or more multicast packets having multicast destination addresses corresponding to device routing domains.

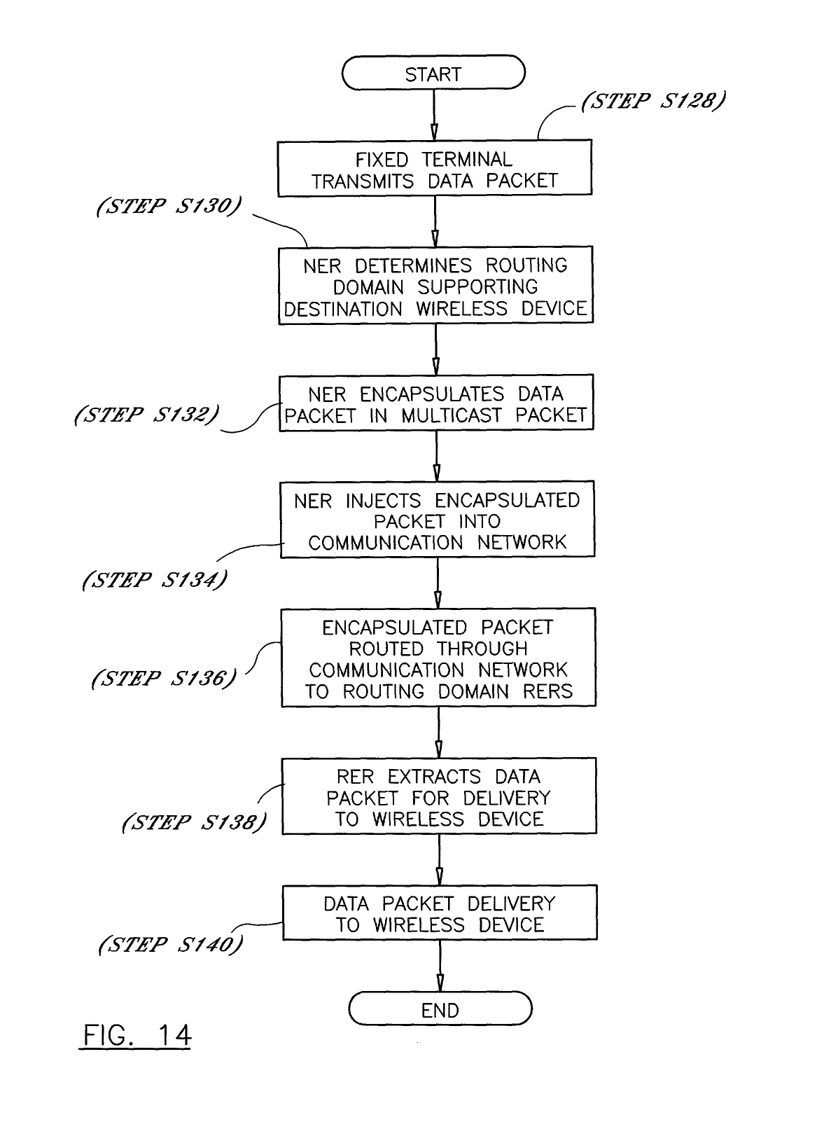

FIG. 16 shows an example of an encapsulation packet arrangement constructed in accordance with the principles of the second aspect of the present invention. Routing domain encapsulated packet 104 constructed by network edge router 12 corresponding to the sending terminal 18 preferably includes multicast encapsulation header 106, original data packet header 108, and user data payload 110. Multicast encapsulation header 106 includes information such as the source unicast address of the encapsulating network edge router 12 and destination multicast address, and other header data found in typical packet headers, such as an IPv6 header.

Original data packet header 108 is the header created by terminal 18 and includes the unicast source address of terminal 18 and the unicast address of destination device 26. For example, original data packet header is an IPv6 header. User data payload 110 is the user data content sent by terminal 18.

Referring again to FIG. 14, network edge router 12 injects the encapsulated multicast packet into communication network 16 (step S134) by transmitting the encapsulated packet via communication interfaces 36 associated with the multicast addresses for the routing domains of the destination device.

The encapsulated packet is routed through the communication network to the destination radio edge routers (RER) (step S136) using known multicast routing techniques. When an encapsulated packet arrives at radio edge routers 14 supporting destination mobile device 26, each destination radio edge router 14 extracts the original data packet (original header 108 and data payload 110) for delivery to the mobile device (step S138). The data packet is delivered to the destination mobile device (step S140) via the wireless communication portion of the network, for example, base stations 22 and base station communication links 24.

Like the previous aspect, this aspect of the present invention advantageously provides macro diversity. For example, in a case where mobile device 26 is within a routing domain supported by multiple radio edge routers, intermediate router 17 assembles multiple multicast packets for transmission to each of the radio edge routers 14 in which the mobile device 26 resides. It is further contemplated that alternate forms of macro diversity support can be used. For example, a proxy device similar to location updating unit 30 can be used to transmit multiple copies of the multicast packet to the corresponding radio edge routers, thereby relieving network edge router 12 of the burden to generate and transmit multiple multicast packets. Further, macro diversity can be implemented in one or more of the radio edge routers 14 which, upon recognizing that the receiving encapsulated packet is supported by additional radio edge routers 14, can transmit copies of the encapsulated packet to the other radio edge routers 14 for delivery to the mobile device 26. In other words, network edge routers and 12 and intermediate routers 17 can be configured to function as radio edge routers, i.e. support base stations 22.

This aspect of the present invention advantageously provides an environment in which network initialization conveniently does not require any pre-configuration. Further, no routing protocols need to be exchanged between routers because routing is based on generally fixed routing domains. Although mobile device 26 moves from routing domain to routing domain, routing of the packet via an appropriate communication interface 36 is based on a table lookup and known multicast routing techniques, and not a complicated signaling protocol.

A result is that this aspect of the present invention advantageously minimizes processing resources and avoids the delays added by conventional signaling requirements. As such, this aspect of the present invention allows high speed data communication between terminal 18 and mobile device 26 in a manner which does not facilitate dropped data packets due to network delay and buffering overflow. The present invention provides a system by which voice over IP, video streaming and other high data rate applications requiring high packet delivery percentages are supported.

Further, this aspect of the present invention advantageously provides an environment in which known hardware components can be used as intermediate network switches 17 by supporting the use of known packet headers and multicast packet routing methods. As such, this aspect of the present invention advantageously allows service providers the ability to re-use their existing infrastructure.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for transmitting data to a mobile device, comprising:
receiving location data from the mobile device; and
encapsulating a data packet in an encapsulation packet, the encapsulation packet having a destination address corresponding to the location data;
determining at least a portion of a network path to the device based on the location data;
decapsulating the encapsulated data packet at a network switch; and
transmitting the data packet to the mobile device.

2. The method according to claim 1, further comprising the steps of:
storing a first mapping between a unicast address of the mobile device and the location data corresponding to the device;
receiving a data packet from a terminal, the data packet including the destination address of the mobile device; and
using the first mapping to determine the location data of the device based on the destination address of the device.

3. The method according to claim 1, wherein the location data is comprised of a routing domain.

4. The method according to claim 1, wherein the location data is comprised of global positioning data.

5. The method according to claim 2, wherein the determining function comprises evaluating a second mapping, the second mapping having the location data corresponding to the device and a respective multicast address to be used as the destination address of the encapsulation packet.

6. The method according to claim 5, wherein the location data is comprised of a routing domain.

7. The method according to claim 2, wherein the determining function comprises:
storing a second mapping, the second mapping having a location data range corresponding to network switches supporting a respective coverage zone and at least one communication interface to be used to transmit the encapsulation packet; and
evaluating the second mapping to determine the at least one communication interface to be used to transmit the encapsulation packet based on the location data range which includes the location data.

8. The method according to claim 7, wherein the location data range is a range of global positioning coordinates and the location data includes global positioning data.

9. A system for transmitting data across a communication network from a terminal to a mobile device, the system comprising:
at least one first router having at least one communication interface, the at least one communication interface receiving location data from the mobile device; and
at least one second router having:
at least one communication interface, the at least one communication interface receiving the location data from the at least one first router and receiving a data packet from the terminal, the data packet including a unicast address of the mobile device; and
a central processing unit, the central processing unit executing functions including:
determining at least a portion of a network path to the device based on the location data; and
using the portion of the determined network path to send, via the at least one communication interface, the data packet to the at least one first router which received the location data from the device.

10. The system according to claim 9, wherein the at least one second router further comprises a storage unit and wherein the central processing unit further executes a function including storing a first mapping in the storage unit between the unicast address corresponding to the mobile device and the location data corresponding to the device.

11. The system according to claim 9, wherein the location data is comprised of a routing domain.

12. The system according to claim 9, wherein the location data is comprised of global positioning data.

13. The system according to claim 9, further comprising a location updating unit, the location updating unit receiving the location data from the at least one first router and transmitting the location data to the at least one second router.

14. The system according to claim 10, wherein the central processing unit in the at least one second router further executes a function including encapsulating the data packet in an encapsulation packet, and wherein the at least one first router decapsulates the data packet.

15. The system according to claim 14, wherein the determining function is comprised of retrieving a second mapping from the storage unit, the second mapping having the location data corresponding to the device and a respective multicast address interface to be used as the destination address of the encapsulated packet.

16. The system according to claim 15, wherein the location data is comprised of a routing domain.

17. The system according to claim 10, wherein the storage unit stores a second mapping, the second mapping having a location data range corresponding to a coverage zone for a respective first router and at least one corresponding communication interface on the second router to be used to transmit the encapsulation packet, and wherein the determining function includes evaluating the second mapping to determine the at least one communication interface to be used to transmit the encapsulation packet based on the location data range which includes the location data.

18. The system according to claim 17, wherein the location data range is a range of global positioning coordinates and the location data includes global positioning data.

19. A network switch for a communication network in which the network switch facilitates communication between a device and a terminal coupled to the communication network, the network switch comprising:
at least one communication interface, the at least one communication interface receiving location data corresponding to the device and receiving a data packet from the terminal, the data packet including a destination unicast address of the device; and
a central processing unit, the central processing unit executing functions including:
determining at least a portion of a network path to the device based on the location data; and
using the portion of the determined network path to send, via the at least one communication interface, the data packet to the device.

20. The network switch according to claim 19, further comprising a storage unit, wherein the central processing unit further executes a function including storing a first mapping in the storage unit between the destination unicast address corresponding to the device and the location data corresponding to the device.

21. The network switch according to claim 19, wherein the location data is comprised of a routing domain.

22. The network switch according to claim 19, wherein the location data is comprised of global positioning data.

23. The network switch according to claim 20, wherein the central processing unit further executes a function including encapsulating the data packet in an encapsulation packet.

24. The network switch according to claim 23, wherein the determining function is comprised of retrieving a second mapping from the storage unit, the second mapping having the location data corresponding to the device and a respective multicast address to be used as the destination address of the encapsulation packet.

25. The network switch according to claim 24, wherein the location data is comprised of a routing domain.

26. The network switch according to claim 20, wherein the storage unit stores a second mapping, the second mapping having a location data range for a coverage zone and at least one corresponding communication interface to be used to transmit the encapsulation packet, and wherein the determining function includes evaluating the second mapping to determine the at least one communication interface to be used to transmit the encapsulation packet based on the location data range which includes the location data.

27. The network switch according to claim 26, wherein the location data range is a range of global positioning coordinates and the location data includes global positioning data.

28. The network switch according to claim 19, wherein the data packet includes streaming data.
